(19) United States
(12) Patent Application Publication
(10) Pub. No.: US 2011/0261316 A1
(43) Pub. Date: Oct. 27, 2011

(54) LENS ASSEMBLY FOR VIEWING THREE-DIMENSIONAL (3D) IMAGES

(75) Inventor: Su AN PARK, Wonju-si (KR)

(73) Assignee: KOREA O.G.K CO., LTD., Wonju-si (KR)

(21) Appl. No.: 12/816,532

(22) Filed: Jun. 16, 2010

(30) Foreign Application Priority Data
Apr. 22, 2010 (KR) 10-2010-0037201
Apr. 23, 2010 (KR) 10-2010-0038056

(51) Int. Cl. G02C 7/12; G02B 27/26

(52) U.S. Cl. 351/158; 359/465

(57) ABSTRACT

Disclosed is a lens assembly for viewing three-dimensional (3D) images. More specifically, disclosed is a lens assembly for viewing three-dimensional (3D) images wherein one lens is integrated with a prescription lens realizing three dimensional imaging and processed to be suited to the poor eyesight of a watcher. The prescription lens includes a PVA film having an outer side linked to a phase difference film, a PC panel linked to an inner side of the PVA film, and a prescription lens integrally stuck or adhered to the inner side of the PC panel, thus advantageously imparting three dimensional imaging and vision correction effects to one lens and thus realizing comfortable wearing and clear and superior three-dimensional imaging.

### BACKGROUND OF THE INVENTION

1. Field of the Invention

The present invention relates to a lens assembly for viewing three-dimensional (3D) images. More specifically, the present invention relates to a lens assembly for viewing three-dimensional (3D) images wherein one lens is integrated with a prescription lens realizing three dimensional imaging and being processed to be suited to the low eyesight of a watcher.

2. Description of the Related Art

Imaging technologies to realize three-dimensional images are divided into an active imaging manner (using an LCD) and a passive imaging manner (using a polarizing film). Of these, the active imaging system has a structure comprising a polarizing layer/glassy liquid crystal/polarizing layer, wherein the polarizing layer may be composed of TAC/PVA/TAC or PC/PVA/PC.

A structure wherein prescription glasses are superimposed on 3D active glasses provided with such a lens, that is, two glasses are worn simultaneously, may disadvantageously cause considerable user discomfort and cannot render viewing with superior three-dimensional effects and clear image quality due to light refraction or deterioration in light transmission in the space provided between the prescription lens and the 3D lens.

Accordingly, the present invention solves the aforementioned problems, i.e., inconvenience of users having different eyesights and drawbacks of conventional lens assemblies for viewing three-dimensional (3D) images.

### SUMMARY OF THE INVENTION

Therefore, the present invention has been made in view of the above problems and provides a lens assembly for viewing three-dimensional (3D) images wherein the inner surface of one lens is integrally stuck or adhered to a prescription lens which realizes three dimensional imaging and is suited to the eyesight of a watcher, to realize comfortable wearing, and clear and superior three-dimensional imaging.

In accordance with one aspect of the present invention, provided is a lens assembly for viewing three-dimensional (3D) images including a passive lens (using a polarizing film), wherein a prescription lens is joined to the surface of the passive lens to prevent light refraction and thus improve light transmission, thereby realizing clear three-dimensional imaging.

The passive lens includes: a PVA film having an outer side linked to a phase difference film; a PC panel linked to an inner side of the PVA film; and a prescription lens integrally stuck or adhered to an inner side of the PC panel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating eyeglasses for viewing three-dimensional (3D) images of the present invention;

FIG. 2 is an exploded sectional view illustrating a lens assembly for viewing three-dimensional (3D) images of the present invention;

FIG. 3 is an exploded sectional view illustrating a lens assembly for viewing three-dimensional (3D) images of the present invention;

FIG. 4 is an exploded sectional view illustrating a lens assembly for viewing three-dimensional (3D) images of the present invention; and

FIG. 5 is an exploded sectional view illustrating a lens assembly for viewing three-dimensional (3D) images of the present invention.

### DETAILED DESCRIPTION OF THE INVENTION

Hereinafter, general configurations of the present invention and specific effects obtained therefrom will be described with reference to the annexed drawings in detail.

Terms and words used in the specification and claims should not be construed as being restricted to ordinary meanings or dictionary definitions. Based on the fundamental rules that an inventor can appropriately define the meanings of terms so that the disclosure will be thorough and complete and will fully convey the scope of the invention to those skilled in the art, terms and words used in the specification and claims should be construed consistently with the technical spirit of the invention. Therefore, since embodiments described in the description and constructions illustrated in the drawings are only exemplary embodiments of the present invention and do not mean all of the sprit and scope of the present invention, it will be understood that various modifications and substitutions as alternatives of the embodiments may be made therein at the filing date. The same reference numerals designate identical elements throughout the drawings.

The present invention provides a lens assembly for viewing three-dimensional (3D) images wherein a lens assembly for viewing three-dimensional (3D) images including a passive lens (including a passive lens provided with a polarizing film) is integrated with a prescription lens, to minimize light refraction in the space provided between the prescription lens and the liquid crystal lens, and thus improve light transmission, thereby realizing superior three-dimensional imaging and clear image quality.

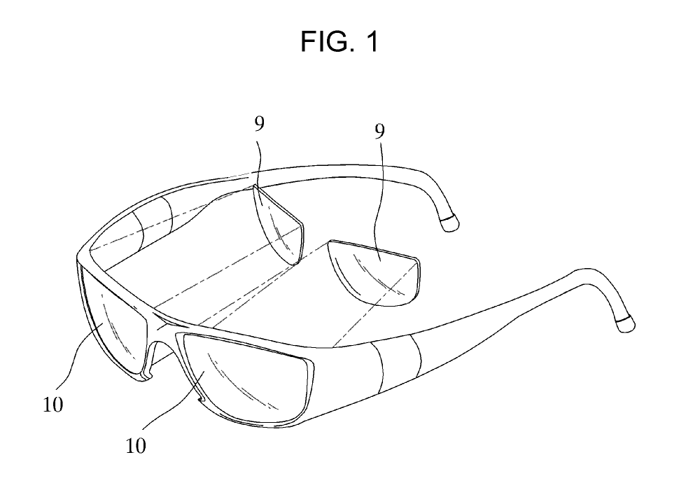

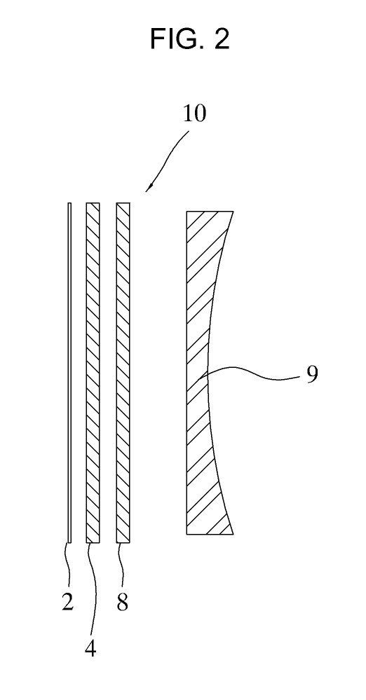

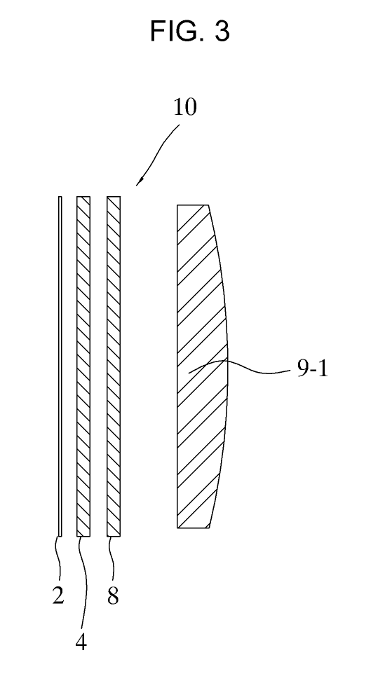

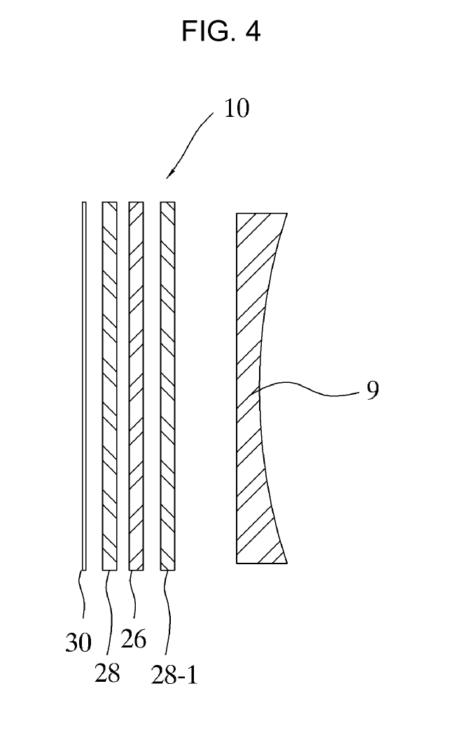

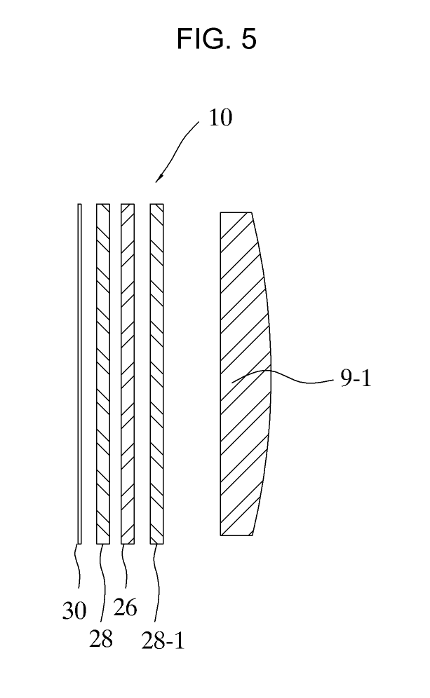

FIG. 1 is an assembled perspective view illustrating a state wherein a prescription lens is joined to eyeglasses for viewing three-dimensional (3D) images. FIG. 2 is an exploded sectional view illustrating a lens assembly for viewing three-dimensional (3D) images of the present invention. FIG. 3 is an exploded sectional view illustrating a lens assembly for viewing three-dimensional (3D) images of the present invention. FIG. 4 is an exploded sectional view illustrating a lens assembly for viewing three-dimensional (3D) images of the present invention. FIG. 5 is an exploded sectional view illustrating a lens assembly for viewing three-dimensional (3D) images of the present invention.

As shown in FIG. 2, the present invention provides a lens assembly wherein a PVA film 4 having an outer side linked to a phase difference film 2, a PC panel 8 linked to an inner side of the PVA film 4 and a prescription lens 9 linked to the inner side of the PC panel 8 are stuck or adhered to one another such that they are laminated in this order.

The phase difference film 2 enables left and right imaging/polarizing to be separately transferred to the eyes of a watcher through the lens and causes binocular disparity, enabling three-dimensional imaging.

In addition, the PVA (polyvinyl alcohol) film 4 is prepared through stretching and dying processes including stretching a film in one direction and arranging a substance such as iodine, dichroic dyes or the like between a PVA polymer in the other direction, so that the PVA film 4 permeates light emitted in one direction and absorbs light emitted in the other direction, thereby acting as a polarizer.

In addition, the prescription lens 9 adhered to the inner side of the PC (polycarbonate) panel 8 is processed based on the previously measured eyesight of the user, which is composed of a material selected from CR, PC, glass, acryl and organic compounds.

The prescription lens 9, which realizes three-dimensional imaging and is suited to the eyesight of a user, is integrally added to a monolithic lens 10, to enable convenient wearing and viewing of high-quality images.

As shown in FIGS. 2 and 3, the prescription lens 90 and 90-1 of the present invention has a flat outer surface and a concave (or convex) inner surface, which is formed by sticking or adhering these surfaces to each other.

In another embodiment, as shown in FIG. 4, a lens assembly for viewing 3D images including a passive lens (using a polarizing film) has a structure wherein a prescription lens 9 (or 9-1) is adhered to the surface of the passive lens 10.

The passive lens 10 has a structure wherein TAC films 28 and 28-1 are adhered to the outer sides of a PVA film 26 and a phase difference film 30 is adhered to the outer side of the outer TAC film 28, wherein the phase difference film enables separate transfer of left/right imaging and polarizing to the eyes of viewers through the lens and realizes binocular disparity, enabling three-dimensional imaging. In order to realize three-dimensional imaging with superior three-dimensional effects and clear image quality, wearing a polarizing lens provided with the phase difference film is required. In addition, the prescription lens 9 is bound to the passive lens 10 having the structure as mentioned above, to conveniently view superior three-dimensional images.

In addition, as shown in FIG. 4, for the lens assembly for viewing 3D images, TAC (triacetyl cellulose) films 28 and 28-1 integrally adhered to the both sides of the PVA (polyvinyl alcohol) film 26 provided in the center are oriented in an optically identical direction and exhibit superior transparency and strength, and good dimensional stability when faced with variations in temperature and humidity.

As shown in FIGS. 4 and 5, the prescription lens 90 or 90-1 of the present invention has a flat outer surface and a concave (or convex) inner surface, which is formed by sticking or adhering these surfaces to each other.

In another embodiment, the prescription lens may have a convex outer surface and a concave (or convex) inner surface.

As apparent from the fore-going, the present invention advantageously provides a lens assembly for viewing three-dimensional (3D) images integrated with a prescription lens processed to be suited to the eyesight of a viewer wherein a lens for viewing 3D images is adhered to a gasket and the gasket is integrated with the prescription lens, thus considerably advantageously realizing three dimensional imaging without wearing any prescription lens.

The lens for viewing three-dimensional images is integrated with a gasket-provided prescription lens processed to be suited to the low eyesight of a viewer, thus advantageously providing comfortable wearing and clear 3D imaging.

The lens assembly eliminates the necessity of wearing a prescription lens on a lens for viewing three dimensional images, thus advantageously providing comfortable, clear, and superior image-quality imaging and thus realizing more interesting 3D imaging.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A lens assembly for viewing three-dimensional (3D) images comprising a passive lens (using a polarizing film), wherein a prescription lens is joined to the surface of the passive lens.

2. The lens assembly according to claim 1, wherein the prescription lens is integrally stuck or adhered to the surface of the passive lens.

3. The lens assembly according to claim 1, wherein the passive lens comprises:
a PVA film having an outer side linked to a phase difference film;
a PC panel linked to an inner side of the PVA film; and
a prescription lens integrally stuck or adhered to an inner side of the PC panel.

4. The lens assembly according to claim 1, wherein the passive lens comprises:
a PVA film provided in the center thereof;
a pair of TAC panels adhered to both sides of the PVA film;
a phase difference film adhered to the outer side of the outer TAC panel; and
a prescription lens adhered to the inner side of the inner TAC panel.

5. The lens assembly according to claim 1, wherein the prescription lens is composed of a material selected from CR, PC, glass, acryl and organic compounds.

6. The lens assembly according to claim 1, wherein the prescription lens has a flat outer surface and a concave or convex inner surface.

7. The lens assembly according to claim 1, wherein the prescription lens has a convex outer surface and a concave or convex inner surface.
